(19) United States
(12) Patent Application Publication
(10) Pub. No.: US 2024/0078487 A1
(43) Pub. Date: Mar. 7, 2024

(54) CONSTRUCTING AND UTILIZING A SEARCH STRUCTURE FOR IDENTIFYING TASKS TO ASSIGN TO ENTITIES

(71) Applicant: Verizon Patent and Licensing Inc., Basking Ridge, NJ (US)

(72) Inventor: David P Manning, Christchurch (NZ)

(21) Appl. No.: 17/901,367

(22) Filed: Sep. 1, 2022

(51) Int. Cl. G06Q 10/06; G06Q 10/10

(52) U.S. Cl. CPC G06Q 10/06316; G06Q 10/1097

(57) ABSTRACT

One or more computing devices, systems, and/or methods for constructing and utilizing a search structure for identifying tasks to assign to entities are provided. The search structure is constructed to partition tasks and represent time constraints for performing the tasks and distance constraints corresponding to locations of the tasks. A search of the search structure is performed to identify a set of nearest tasks with respect to a target task. Tasks within the set of nearest tasks may be assigned to an entity to perform.

### BACKGROUND

Many companies assign tasks to employees to perform. These tasks may be located in different geographical regions. The tasks may also have certain times of day and/or dates during which the tasks can be performed. Also, certain employees may be capable of performing only certain tasks. In an example, a nationwide residential service company may provide residential appliance repair across the country. The residential service company may assign appliance repair tasks to repair technicians. These appliance repair tasks may be located across the country and are to be performed on certain dates at certain times of the day. As the number of tasks and entities that can perform the tasks increase, task scheduling becomes a resource intensive operation that consumes a large amount of computing resources due to the sheer number of potential task assignment combinations to evaluate.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating an example scenario associated with constructing and utilizing a search structure for identifying tasks to assign to entities;

FIG. 2 is a diagram illustrating an example scenario associated with constructing and utilizing a search structure for identifying tasks to assign to entities;

FIG. 3 is a flow chart illustrating an example method for constructing and utilizing a search structure for identifying tasks to assign to entities;

FIG. 4A is a diagram illustrating an example of a search structure;

FIG. 4B is a diagram illustrating an example scenario associated with constructing and utilizing a search structure for identifying tasks to assign to entities;

FIG. 5 is a diagram illustrating an example scenario associated with instructing an entity to perform tasks assigned to the entity;

FIG. 6 is a diagram illustrating an example scenario associated with instructing a robot device to perform tasks assigned to the robot device;

FIG. 7 is an illustration of example networks that may utilize and/or implement at least a portion of the techniques presented herein;

FIG. 8 is an illustration of a scenario involving an example configuration of a computer that may utilize and/or implement at least a portion of the techniques presented herein;

FIG. 9 is an illustration of a scenario involving an example configuration of a client that may utilize and/or implement at least a portion of the techniques presented herein;

FIG. 10 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

One or more systems and/or techniques for constructing and utilizing a search structure for identifying tasks to assign to entities are provided. Scheduling tasks to be performed by entities (e.g., a plumbing job performed by a plumber, a pool cleaning job performed by a pool technician, a package delivery task to be performed by a drone or robot, a warehouse task to be performed by warehouse machinery, etc.) is a difficult problem for management systems, such as fleet management systems, to address at scale when there are hundreds to thousands of tasks and/or entities capable of performing certain tasks. Task scheduling becomes more challenging when the tasks are located across a large region, such as across a state or country, and thus locations of tasks and travel distance/times between tasks must be taken into account. Task scheduling is even more difficult when tasks are to be performed at certain times or on certain days. Because of the sheer number of combinations to consider when scheduling tasks (e.g., a solution space for 100 tasks could result in 10,000 evaluations when considering pairs of tasks to assign to an entity to sequentially perform), a significant amount of processing time and computing resources is consumed. This limits the number of tasks that can be processed and scheduled. An example of this task scheduling problem is a vehicle routing problem (VRP) that is a non-deterministic polynomial time problem (NP-Hard problem) that is typically solved using heuristics to guide limited exploration of the solution space (e.g., consideration of only some pairs of tasks), which may use nearest neighbor heuristics. However, there is currently no efficient technique for calculating the k-nearest neighbors used for scheduling when there are time constraints where a task is to be performed within a limited time window (e.g., tasks that are to be performed on certain days or during certain times of the day). A kd-tree can be used to improve the efficiency of the k-nearest neighbors determination when dealing with spatial constraints, however, the kd-tree does not take into consideration temporal constraints.

The techniques provided herein improve the efficiency of the k-nearest neighbors determination in a manner that significantly reduces the time and processing resources for identifying k-nearest neighbors of tasks that can be assigned to entities to perform. The efficiency of the k-nearest neighbors determination is improved through the construction of a search structure (a search tree) that is searched in a manner that more efficiently identifies k-nearest neighbors used to assign tasks for entities (e.g., k-nearest tasks to a target task that could be scheduled for sequential performance by a person, computer, equipment/machinery, a drone, a robot, etc.). In some embodiments, the construction and searching of the search structure reduces the time from minutes to seconds for identifying the k-nearest neighbors when taking into account both dimensional and temporal constraints (e.g., 50× speedup when there are 13,000 to 16,000 tasks to schedule). This is because certain branches of tasks can be eliminated from consideration when searching the search structure.

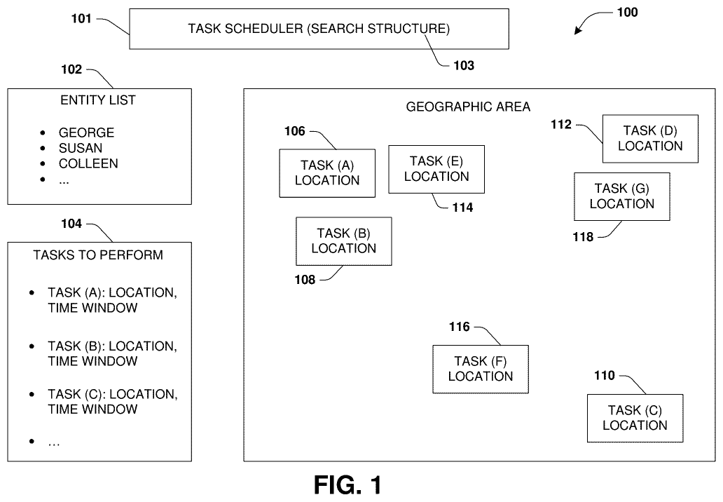

FIG. 1 illustrates an example system 100 for constructing and utilizing a search structure for identifying tasks to assign to entities. The system 100 comprises a task scheduler 101. The task scheduler 101 may be implemented as software and/or hardware (e.g., hosted through service 702 and/or computer 704, implemented as instructions stored in memory 802 and executed by processor 810, etc.). The task scheduler 101 takes an entity list 102 of entities (e.g., people, robots, drones, machinery, autonomous delivery vehicles, etc.) available to perform tasks as input. The task scheduler 101 takes a task list 104 of tasks that are to be assigned to entities to perform as input. The task list 104 may specify tasks, locations at which the tasks are to be performed, and time intervals/windows during which the tasks are to be performed (e.g., an earliest start time of a task, a latest start time of a task, a task duration, a date at which a task is to be performed, etc.). In some embodiments, the tasks may be located at different locations within a geographic region, such as where a task (A) is located at a task (A) location 106, a task (B) is located at a task (B) location 108, a task (C) is located at a task (C) location 110, a task (D) is located at a task (D) location 112, a task (E) is located at a task (E) location 114, a task (F) is located at a task (F) location 116, a task (G) is located at a task (G) location 118, etc.

The task scheduler 101 performs task scheduling by assigning a certain sequences of tasks to entities (e.g., George will perform task (A), task (E), and then task (B); Susan will perform task (G) and then task (D); Colleen will perform task (F) and then task (C); etc.). As part of performing the task scheduling, the task scheduler 101 identifies sets of k-nearest neighbors with respect to target tasks (e.g., a first set of k-nearest neighbor tasks with respect to task (A); a second set of k-nearest neighbor tasks with respect to task (B); etc.). Instead of considering every pair of tasks during the identification of the k-nearest neighbors, the task schedule 101 is configured to construct a search structure 103 that can be used to more efficiently identify k-nearest neighbor tasks for a target task. The k-nearest neighbor tasks can be more efficiently identified because not all combinations/pairs of tasks are considered, and certain branches of the search structure 103 used to partition tasks can be skipped in their entirety so that combinations that include tasks of those branches can be skipped. This significantly reduces the number of comparisons performed (e.g., merely 181 comparisons instead of 23206 comparisons performed by conventional techniques for an average of a 32-nearest neighbor query comparison where there are date, time of day, and location constraints). The search structure 103 is used to partition the tasks, and represent time constraints for performing the tasks and distance constraints corresponding to the locations of the tasks. The search structure 103 is searched in a manner that takes into account the time constraints and the distance constraints so that a subset of feasible combinations are taken into account and other combinations of tasks are skipped (e.g., two tasks that are to be performed at 1:00 pm and 2:00 pm, but are located 5 hours from one another are skipped because sequentially performing the tasks is not feasible).

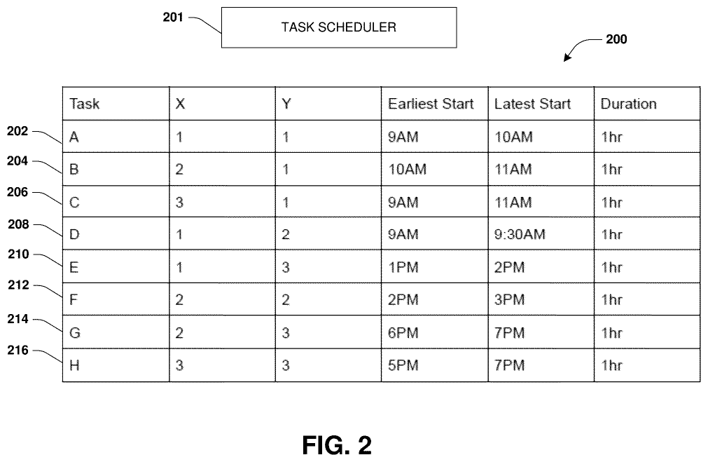

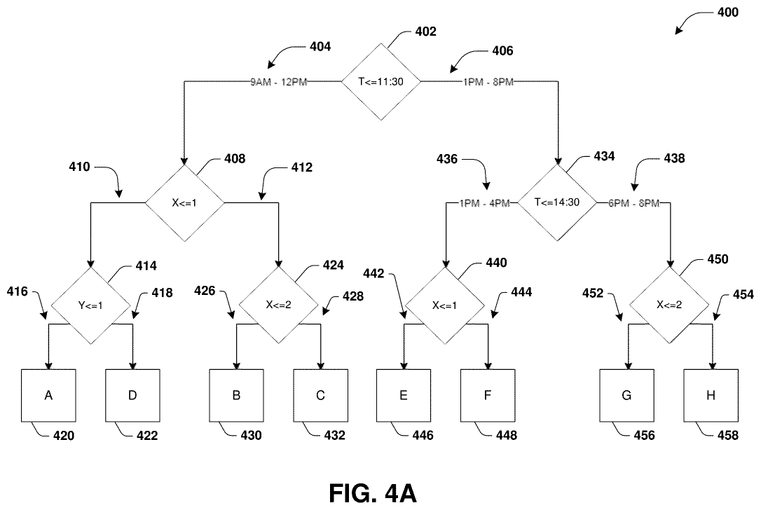

FIG. 2 illustrates an example of tasks 200 having time constraints and distance constraints. A task scheduler 201 may generate a search structure to represent and partition the tasks 200 in relation to the time constraints and distance constraints so that the search tree can be efficiently searched to identify what combinations of tasks to consider for identify k-nearest neighbor tasks. The tasks 200 includes a task (A) 202 that is located at coordinates X=1 and Y=1, has an earliest start time of 9 AM, a latest start time of 10 AM, and a task execution duration of 1 hour. The tasks 200 includes a task (B) 204 that is located at coordinates X=2 and Y=1, has an earliest start time of 10 AM, a latest start time of 11 AM, and a task execution duration of 1 hour. The tasks 200 includes a task (C) 206 that is located at coordinates X=3 and Y=1, has an earliest start time of 9 AM, a latest start time of 11 AM, and a task execution duration of 1 hour. The tasks 200 includes a task (D) 208 that is located at coordinates X=1 and Y=2, has an earliest start time of 9 AM, a latest start time of 9:30 AM, and a task execution duration of 1 hour. The tasks 200 includes a task (E) 210 that is located at coordinates X=1 and Y=3, has an earliest start time of 1 PM, a latest start time of 2 PM, and a task execution duration of 1 hour. The tasks 200 includes a task (F) 212 that is located at coordinates X=2 and Y=2, has an earliest start time of 2 PM, a latest start time of 3 PM, and a task execution duration of 1 hour. The tasks 200 includes a task (G) 214 that is located at coordinates X=2 and Y=3, has an earliest start time of 6 PM, a latest start time of 7 PM, and a task execution duration of 1 hour. The tasks 200 includes a task (H) 216 that is located at coordinates X=3 and Y=3, has an earliest start time of 5 PM, a latest start time of 7 PM, and a task execution duration of 1 hour. In some embodiments, the tasks 220 may be partitioned based upon earliest and/or latest start times (e.g., a first branch may include tasks before 12 PM and a second branch may include tasks after 12 PM). In some embodiments, the tasks 220 may be partitioned based upon X coordinates and/or Y coordinates (e.g., a first branch may include tasks with X coordinates less than 1 and a second branch includes tasks that do not have X coordinates less than 1). It may be appreciated that an example of a search structure is illustrated and further described in relation to FIG. 4A.

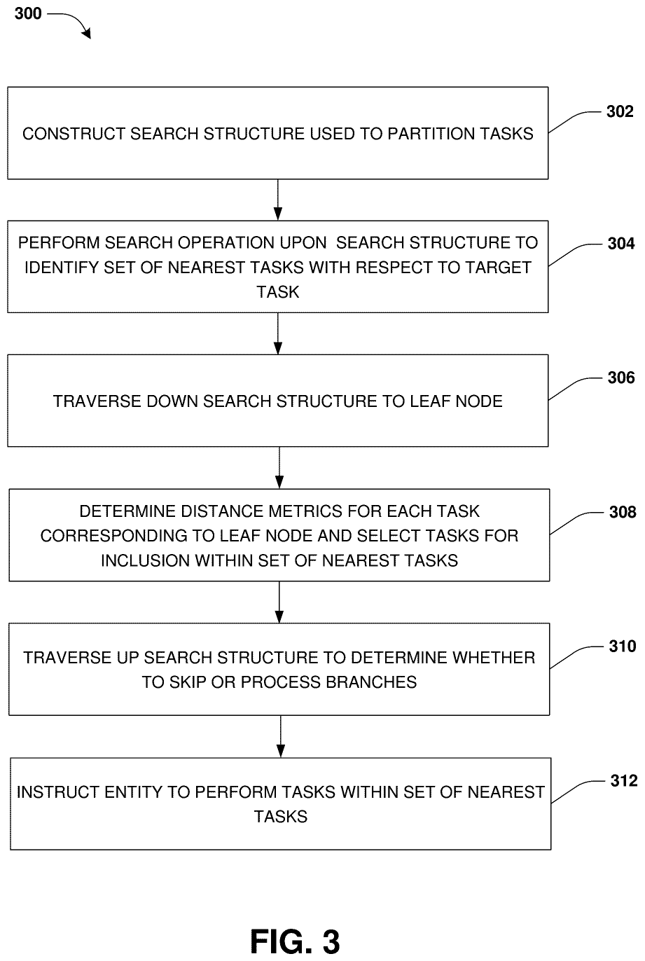

FIG. 3 is a flow chart illustrating an example method for constructing and utilizing a search structure for identifying tasks to assign to entities. During operation 302 of method 300, a search structure (e.g., a search tree) is constructed to partition tasks that are to be assigned to entities to perform (e.g., furnace installation tasks to assign to technicians; warehouse tasks to assign to warehouse equipment, machines, and/or robots; etc.). The tasks may be associated with time constraints of when the tasks are to be performed. A time constraint may correspond to a time of day constraint corresponding to a time interval/window during which a task is to be performed (e.g., an earliest start time of 9 AM and/or a latest start time of 10 AM for a 3 hour furnace installation task). A time constraint may correspond to a date constraint corresponding to a date during which a task is to be performed (e.g., the furnace installation task is to be performed on a particular calendar date or day of the week). The tasks may be associated with distance constraints corresponding to locations of where the tasks are to be performed, which may also relate to distances and/or travel times from traveling from one task to another task. The search structure is constructed to represent the time constraints for performing the tasks and the distance constraints corresponding to locations of performing the tasks.

In some embodiments of constructing the search structure, ranges of time intervals are stored within branches of the search structure. The ranges of time intervals are stored within the branches based upon the time constraints corresponding to time of day constraints. Thus, a branch may store time intervals during which tasks, partitioned along that branch, are to be performed. In some embodiments, a dimension is selected for partitioning the search structure based upon the dimension maximizing a distance between a first branch and a second branch of the search structure (e.g., tasks to be performed in the morning and tasks to be performed in the evening, which have a maximum distance in a temporal search space). In some embodiments, spatial dimensions are selected for partitioning the search structure. A medium of the spatial dimensions is determined (e.g., spatial dimensions derived from the distance constraints of where the tasks are to be performed). The medium of the spatial dimensions is used to partition the search structure. The medium of the spatial dimensions are stored as a boundary value for the partition of the search structure. In some embodiments, temporal dimensions are selected for partitioning the search structure (e.g., time constraints of when the tasks are to be performed). A midpoint of time intervals of the temporal dimensions is determined. The search structure is partitioned by a median of the midpoint of the time intervals of the temporal dimensions. A range of the time intervals is stored in each branch of the search structure resulting from the partitioning.

In some embodiments, a task may have multiple time intervals (time windows) during which the task can be performed. In some embodiments, the multiple time intervals (e.g., a first time interval from 9 AM to 10 AM and a second time interval from 10:30 AM to 11:30 AM) may be combined for a task into a combined time interval for the task (e.g., a combined time interval of 9 AM to 11:30 AM). In some embodiments, instead of combining the time intervals, separate instances of the task for each time interval is inserted into the search structure (e.g., a first instance of the task at the first time interval from 9 AM to 10 AM and a second instance of the task at the second time interval from 10:30 AM to 11:30 AM are separately inserted into the search structure). A determination as to whether to combine the multiple time intervals/windows or create separate instances of the task for each time interval/window may be based upon a distance (a temporal distance along a temporal dimension) between each time interval. A threshold (e.g., a time difference of 2 hours or any other time duration threshold value) may be used to determine whether to combine the multiple time intervals or not such that if a difference between the latest start time of the first interval (e.g., 10 AM) and the earliest start time of the second time interval (e.g., 10:30 AM) is less than the threshold, then the time intervals are combined, otherwise, the time intervals are not combined and separate instances of the task for each time interval are inserted into the search structure.

Once the search structure is constructed, the search structure can be searched to identify sets of nearest tasks with respect to target tasks in order to assign tasks to entities. In this way, search operations may be iteratively performed upon the search structure to assign tasks to entities to perform based upon the time constraints and the distance constraints for generating a schedule for the entities to perform the tasks. During operation 304 of method 300, a search operation is performed upon the search structure to identify a set of nearest tasks (e.g., k-nearest neighbor tasks) with respect to a target task. As part of performing the search operation, the search structure is traversed down through a path corresponding to the target task until reaching a leaf node, during operation 306 of method 300. During operation 308 of method 300, distance metrics (e.g., distances in terms of a search space corresponding to time and/or locational distance, such as along a temporal dimension and/or a locational dimension) for each task corresponding to the leaf node of the branch are determined based upon the time constraints and/or the distance constraints. The distance metrics are used to select a number of tasks (e.g., k tasks such as 10 tasks where k=10), associated with the leaf node, for inclusion within the set of nearest tasks. For example, the tasks associated with the leaf node may be sorted based upon the distance metrics to create a sort list of tasks. The select number of tasks are selected from the sorted list of tasks to include within the set of nearest tasks, such as where the select number of tasks have the smallest distance metrics.

Once the set of nearest tasks is initially determined (e.g., an initial set of nearest tasks identified so far by taking into account tasks associated with the leaf node), the search structure is traversed up from the leaf node to a parent node, during operation 310 of method 300. Once the parent node is reached, a determination is made as to whether to skip processing of a branch off the parent node or to process the branch to determine whether to replace any of the tasks currently within the set of nearest tasks with one or more tasks associated with the branch. As part of determining whether to process or skip the branch, a bound of a distance metric for the parent node is determined (e.g., a lower bound of the distance metric derived from time constraints and/or distance constraints of the parent node). The bound of the distance metric for the parent node is compared to a distance metric of a task within the set of nearest tasks (e.g., a task having a largest distance metric). If the bound of the distance metric for the parent node is larger than the distance metric of the task, then the branch can be skipped by the search operation because no tasks in the branch have distance metrics smaller than the largest distance metric of the set of nearest tasks. This greatly reduces the number of comparisons performed by the search operation. If the bound of the distance metric for the parent node is smaller than the distance metric of the task, then the search operation processes the tasks within the branch by performing comparisons of pairings of the target task with the tasks within the branch to see if any pairings have distance metrics smaller than the largest distance metric of the set of nearest tasks. Thus, tasks with the smaller distance metrics may be used to replace tasks within the set of nearest tasks. In this way, the search structure is traversed back up to the root to identify which tasks to include within the set of nearest tasks (e.g., tasks paired with the target task that result in the smallest distance metrics) by selectively processing or skipping certain branches of parent nodes encountered while traversing back up the search structure.

Once the search operations are performed to identify the sets of nearest tasks, the sets of nearest tasks are used to assign tasks to entities to perform. During operation 310 of method 300, an entity is instructed to perform one or more tasks within a set of nearest tasks. In some embodiments, an instruction is sent over a network to a computing device (e.g., a tablet of a technician) for display to the entity. The instructions may be displayed through a user interface, and may be populated with instructions/steps for performing the set of nearest tasks, driving directions to each of the tasks, an order with which to perform the tasks, equipment needed to perform the tasks, contact information for requestors of the tasks, etc. In some embodiments, a command may be transmitted over a network to a device (e.g., a robotic device, an autonomous delivery vehicle, machinery, equipment in a factory or warehouse, a drone, etc.) to control the device to perform a task within the set of nearest tasks.

In some embodiments of a distance metric, the distance metric is based on time, such as a lower bound of a possible time between leaving one task and being able to start a next time. xᵢ∈X is the set of task, wᵢ^{start}, wᵢ^{end} is the start and end of a time window to task xᵢ. tᵢⱼ^{travel} is the travel time between task xᵢ and task xⱼ, and tᵢ^{site} is the time required at site sᵢ for performing task xᵢ. tᵢ^{early}=wᵢ^{start}+tᵢ^{site} and tᵢ^{late}=wᵢ^{end}=tᵢ^{site} as the earliest and latest times that an entity could leave task xᵢ respectively. Accordingly, the distance metric D(i,j) is defined as:

$$D ( i , j ) = \{ \begin{matrix}{t}_{ij}^{travel} & [ {t}_{i}^{early} + {t}_{ij}^{travel} , {t}_{i}^{late} + {t}_{ij}^{travel} ] ⋃ [ {w}_{j}^{start} , {w}_{j}^{end} ] \neq ∅ \\ {w}_{j}^{start} - {t}_{i}^{late} & {t}_{i}^{late} + {t}_{ij}^{travel} \leq {w}_{j}^{start} \\ ∞ & {t}_{i}^{early} + {t}_{ij}^{travel} \geq {w}_{j}^{end}\end{matrix}$$

There are three scenarios. With the first scenario, the task xᵢ can be scheduled such that the entity can travel directly from task xᵢ to task xᵢ and arrive within [wᵢ^{start},wᵢ^{end}], and thus task xᵢ can be started immediately. In this situation D(i,j)=tᵢⱼ^{travel}. With the second scenario, the latest task xᵢ can be scheduled in a manner that will result in an early arrival at task xᵢ, which requires waiting for wᵢ^{start} before being able to start task xᵢ. In this situation, D(i,j)=wᵢ^{start}−tᵢ^{late}. With the third scenario, the earliest task xᵢ can be scheduled does not allow the entity to reach task xᵢ before wᵢ^{end}, and thus scheduling task xᵢ after task xᵢ is not feasible.

The search structure is constructed as a space partitioning tree that handles both geographical dimensions and time intervals/windows. During construction, the search structure is adapt to exploit varying degrees of separability in each dimension (e.g., geographical/locational dimension and temporal dimension). For geographical dimensions, a median value for current tasks is selected as a boundary, and tasks are partitioned as either greater or equal to this boundary or less than the boundary. All values are stored in leaf nodes. The lower bound on D(i,j) where task xᵢ is on one side of a geographic boundary is the lower bound on tᵢ^{travel}ⱼ. This can be constructed from an underlying road network. For example, a lower bound for a latitude boundary can be derived from the great circle distance from sᵢ to the boundary latitude at the longitude of sᵢ, combined with the average speed of the road network. For time windows, time constraints may be user defined where a time of day can be specified independently of desired dates to schedule a task. For example, a user may specify that a task should be scheduled between Oct. 20, 2021 and Oct. 25, 2021 from 6 AM to 7 AM or 10 PM to 11 PM. In order to avoid storing an interval for all combinations of dates and times, two separate time dimensions are added into the search structure, which includes date intervals [dateᵢ^{early} dateᵢ^{end}] and time of day intervals [timeᵢ^{early},timeᵢ^{end}]. Each dimension partitioning of tasks includes calculating a midpoint of an interval for each task; selecting the median of these intervals as the boundary, and partitioning the tasks by midpoints into set Pₗ and Pₗ₊₁. For each partition, a minimum interval containing all tasks in the partition is stored as [pₗ^{start},pₗ^{end}]. For a date partition, Dᵢ^{min}(i) the lower bound on D(i,j), xⱼ∈Pₗ, is given by:

$$D ( i , j ) {x}_{j} ∈ {P}_{i} >= \{ \begin{matrix}0 & [ {t}_{i}^{early} , {t}_{i}^{late} ] ⋃ [ {P}_{l}^{start} , {P}_{l}^{end} ] \neq ∅ \\ {P}_{l}^{start} - {t}_{i}^{late} & {t}_{i}^{late} \leq {P}_{l}^{start} \\ ∞ & {t}_{i}^{early} \geq {P}_{l}^{end}\end{matrix}$$

Because tasks may fall on adjacent dates, time of day intervals are treated as cyclical, and thus an effective lower bound is:

$$D ( i , j ) {x}_{j} ∈ {P}_{i} >= \{ \begin{matrix}0 & [ {time}_{i}^{early} , {time}_{i}^{late} ] ⋃ [ {P}_{l}^{start} , {P}_{l}^{end} ] \neq ∅ \\ {P}_{l}^{start} - {time}_{i}^{late} & {time}_{i}^{late} \leq {P}_{l}^{start} \\ {time}_{i}^{early} - {P}_{l}^{end} & {time}_{i}^{early} \geq {P}_{l}^{end}\end{matrix}$$

To make space partitioning effective, a well-balanced tree with maximized distance between tasks in each partition is created. When constructing the search structure, the following metric is used to select the partitioning dimension at each node:

$$\frac{min ( \vert {P}_{l} \vert , \vert {P}_{l + 1} \vert}{\vert {P}_{l} ⋃ {P}_{l + 1} \vert} \times {median}_{i ∈ {P}_{l + 1} j} ∈ {P}_{i} ( {D}_{l}^{min} ( i ) , {D}_{l + 1}^{min} ( j ) )$$

When building the search structure, the tasks are recursively partitioned by the dimensions that maximizes this metric.

Once the search structure is constructed, a nearest neighbor query (search operation) is performed upon the search structure. With the bounds defined for D(i,j)xⱼ∈Pₗ, the approximate k-nearest neighbors (tasks) to task xᵢ can be found by searching the search structure. The search identifies a leaf node containing xᵢ by following a branch where xᵢ falls. For each xᵢ in the leaf node (each tasks that could be the next task performed after xᵢ), D(i,j) is calculated, and the first k are retained. The search structure is traversed back up to a parent node, and the lower bound is calculated, Dₗ^{min}(i). If this bound is higher than the largest distance metric value retained as far, then the branch is skipped by the search. In this way, the k-nearest neighbors (tasks) can be identified by traversing back up through the search structure.

FIG. 4A is a diagram illustrating an example of a search structure 400. The search structure 400 includes a first node 402 (a root node) used to partition tasks into a first branch 404 for tasks to be performed between 9 AM and 12 PM and a second branch 406 for tasks to be performed between 1 AM and 8 PM. The first branch 404 has a second node 408 used to partition tasks into a third branch 410 and a fourth branch 412 based upon whether an x-coordinate of the tasks is less than or equal two 1. The third branch 410 has a third node 414 used to partition tasks into a fifth branch 416 and a sixth branch 418 based upon whether a y-coordinate of the tasks is less than or equal to 1. The fifth branch leads to a leaf node 420 for a task (A) and the sixth branch leads to a leaf node 422 for task (D). For example, the task (A) is to be performed between 9 AM and 12 PM, has an x-coordinate less than or equal to 1, and has a y-coordinate less than or equal to 1. The task (D) is to be performed between 9 AM and 12 PM, has an x-coordinate less than or equal to 1, and has a y-coordinate that is not less than or equal to 1.

The fourth branch has a fourth node 424 used to partition tasks into a seventh branch 426 and an eighth branch 428 based upon whether an x-coordinate of the tasks is less than or equal to 2. The seventh branch 426 leads to a leaf node 430 for task (B) and the eighth branch 428 leads to a leaf node 432 for task (C).

The second branch 406 has a fifth node 434 used to partition tasks into a ninth branch 436 for tasks to be performed between 1 PM and 4 PM and a tenth branch 438 for tasks to be performed between 6 PM and 8 PM. The ninth branch 436 has a sixth node 440 used to partition tasks into an eleventh branch 442 and a twelfth branch 444 based upon whether the tasks have x-coordinates less than or equal to 1. The eleventh branch 442 leads to a leaf node 446 for task (E) and the twelfth branch 444 leads to a leaf node 448 for task (F). The tenth branch 438 has a seventh node 450 used to partition tasks into a thirteenth branch 452 and a fourteenth branch 454 based upon whether the tasks have x-coordinates less than or equal to 2. The thirteenth branch 452 leads to a leaf node 456 for task (G) and the fourteenth branch 454 leads to a leaf node 458 for task (H). The search structure 400 can be searched to find k-nearest neighbor (tasks) in relation to a target task.

FIG. 4B is a diagram illustrating an example scenario associated with constructing and utilizing a search structure for identifying tasks to assign to entities. In particular, the search structure 400 of FIG. 4A can be searched 450 to identify k nearest neighbors (tasks) in relation to task (A). The search 450 performs a first comparison 462 (e.g., comparison in relation to task (D)), a second comparison 464 (e.g., whether an x-coordinate is greater than 1), a third comparison 466 (e.g., comparison in relation to task (B)), a fourth comparison 468 (e.g., whether an x-coordinate is greater than 2), and a fifth comparison 470 (e.g., whether a time constraint is greater than 1 PM) to determine whether certain branches within the search structure 400 can be skipped by the search.

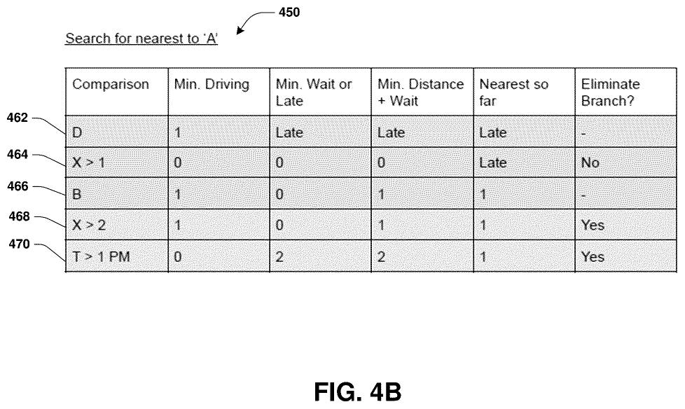

FIG. 5 is a diagram illustrating an example scenario associated with instructing an entity to perform tasks assigned to the entity. A task scheduler 502 may assign one or more tasks for an entity to perform. The task scheduler 502 may transmit an instruction 504 over a network to a computing device 506 of the entity (e.g., a tablet of an installer that is to perform the tasks to install hot water tanks in certain residential homes). The instruction 504 may be displayed through a task instruction user interface 508 on a display of the computing device 506. The task instruction user interface 508 may display information about the tasks assigned to the installed, the order with which to perform the tasks, the locations of the tasks, driving directions to the locations of the tasks, instructions for how to perform the tasks, equipment to bring to perform the tasks, etc.

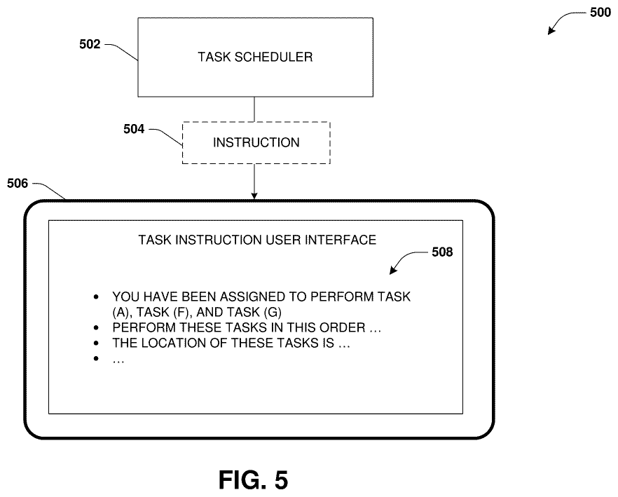

FIG. 6 is a diagram illustrating an example scenario associated with instructing a robot device to perform tasks assigned to the robot device. A task scheduler 602 may assign one or more tasks to a robot device 606 or other device (e.g., machinery, an autonomous delivery vehicle, warehouse equipment, a drone, etc.). The task scheduler 602 may transmit commands 604 to the robot device 606 to control the robot device 606 to perform the commands (e.g., commands to cause the robot device 606 to move, pickup packages, deliver packages, etc.).

According to some embodiments, a method may be provided. The method includes constructing a search structure used to partition tasks, wherein the search structure represents time constraints for performing the tasks and distance constraints corresponding to locations of the tasks; performing a search of the search structure to identify a set of nearest tasks with respect to a target task by: traversing down the search structure through a path corresponding to the target task until reaching a leaf node; determining distance metrics for each task corresponding to the leaf node based upon the time constraints and distance constraints, wherein the distance metrics are used to include a select number of the tasks in the set of nearest tasks; and traversing, from the leaf node, up the search structure to a parent node to determine whether to skip a branch off the parent node or process the branch to determine whether to replace a first task within the set of nearest tasks with a second task within the branch, wherein: a bound of a distance metric for the parent node is determined; and in response to the bound being larger than a first distance metric of the first task, skipping, by the search, the branch; and in response to completing the search, instructing an entity to perform tasks within the set of nearest tasks.

According to some embodiments, the method comprises in response to the bound being smaller than the first distance of the first task, replacing the first task within the set of nearest tasks with the second task within the branch.

According to some embodiments, the method comprises sorting the tasks corresponding to the leaf node based upon the distance metrics to create a sorted list of tasks; and selecting the select number of the tasks from the sorted list of tasks to include within the set of nearest tasks.

According to some embodiments, the method comprises iteratively performing search operations upon the search structure to assign tasks to entities to perform based upon the time constraints and distance constraints; and generating a schedule for the entities based upon the tasks assigned to the entities.

According to some embodiments, the method comprises transmitting an instruction over a network to a computing device for display to the entity, wherein the instructions is populated with instructions for performing the set of nearest tasks.

According to some embodiments, the entity comprises a robotic device, the method comprises transmitting a command over a network to the robotic device to control the robotic device to perform the set of nearest tasks.

According to some embodiments, the time constraints comprises a time of day constraint corresponding to a time window during which a task is to be performed.

According to some embodiments, the time constraints comprises a date constraint corresponding to date during which a task is to be performed.

According to some embodiments, the method comprises storing ranges of time intervals within branches of the search structure based upon the time constraints corresponding to time of day constraints.

According to some embodiments, the method comprises selecting a dimension to partition the search structure based upon the dimension maximizing a distance between a first branch and a second branch of the search structure.

According to some embodiments, the method comprises selecting spatial dimensions for partitioning the search structure; partitioning the search structure by a median of the spatial dimensions; and storing the median as a boundary value.

According to some embodiments, the method comprises selecting temporal dimensions for partitioning the search structure; partitioning the search structure by a median of a midpoint of time intervals of the temporal dimensions; and storing a range of the time intervals in each branch of the search structure.

According to some embodiments, the method comprises combining multiple time intervals for a task into a combined time interval for the task.

According to some embodiments, the method comprises inserting a first instance of a task into the search structure for a first time interval for the task; and inserting a second instance of the task into the search structure for a second time interval for the task.

According to some embodiments, the method comprises determining that a task can be performed during multiple time intervals; determining whether to combine the multiple time intervals for representing the task within the search structure or insert separate instances of the task into the search structure for each of the multiple time intervals based upon a distance between each time interval.

According to some embodiments, a computing device is provided. The computing device comprises a processor coupled to memory, the processor configured to execute instructions to perform operations. The operations includes performing a search of a search structure, used to partition tasks and represent time constraints for performing the tasks and distance constraints corresponding to locations of the tasks, to identify a set of nearest tasks with respect to a target task by: traversing down the search structure through a path corresponding to the target task until reaching a leaf node; determining distance metrics for each task corresponding to the leaf node based upon the time constraints and distance constraints, wherein the distance metrics are used to include a select number of the tasks in the set of nearest tasks; and traversing, from the leaf node, up the search structure to a parent node to determine whether to skip a branch off the parent node or process the branch to determine whether to replace a first task within the set of nearest tasks with a second task within the branch, wherein: a bound of a distance metric for the parent node is determined; and in response to the bound being larger than a first distance metric of the first task, skipping, by the search, the branch; and in response to completing the search, instructing an entity to perform tasks within the set of nearest tasks.

According to some embodiments, the operations include in response to the bound being smaller than the first distance of the first task, replacing the first task within the set of nearest tasks with the second task within the branch.

According to some embodiments, the operations include sorting the tasks corresponding to the leaf node based upon the distance metrics to create a sorted list of tasks; and selecting the select number of the tasks from the sorted list of tasks to include within the set of nearest tasks.

According to some embodiments, a non-transitory computer-readable medium storing instructions that when executed facilitate performance of operations, is provided. The operations include performing a search of a search structure, used to partition tasks and represent time constraints for performing the tasks and distance constraints corresponding to locations of the tasks, to identify a set of nearest tasks with respect to a target task by: traversing down the search structure through a path corresponding to the target task until reaching a leaf node; determining distance metrics for each task corresponding to the leaf node based upon the time constraints and distance constraints, wherein the distance metrics are used to include a select number of the tasks in the set of nearest tasks; and traversing, from the leaf node, up the search structure to a parent node to determine whether to skip a branch off the parent node or process the branch to determine whether to replace a first task within the set of nearest tasks with a second task within the branch, wherein: a bound of a distance metric for the parent node is determined; and in response to the bound being larger than a first distance metric of the first task, skipping, by the search, the branch; and in response to completing the search, instructing an entity to perform tasks within the set of nearest tasks.

According to some embodiments, the operations include in response to the bound being smaller than the first distance of the first task, replacing the first task within the set of nearest tasks with the second task within the branch.

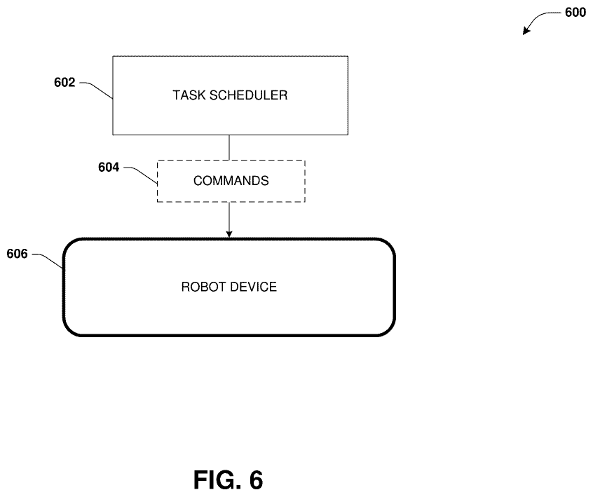

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 707 provided by a cellular provider. As a second such example, one or more client devices 710 may communicate with the service 702 by connecting to the transmission medium 708 via a transmission medium 709 provided by a location such as the user's home or workplace (e.g., a WiFi (Institute of Electrical and Electronics Engineers (IEEE) Standard 702.11) network or a Bluetooth (IEEE Standard 702.15.1) personal area network). In this manner, the computers 704 and the client devices 710 may communicate over various types of transmission mediums.

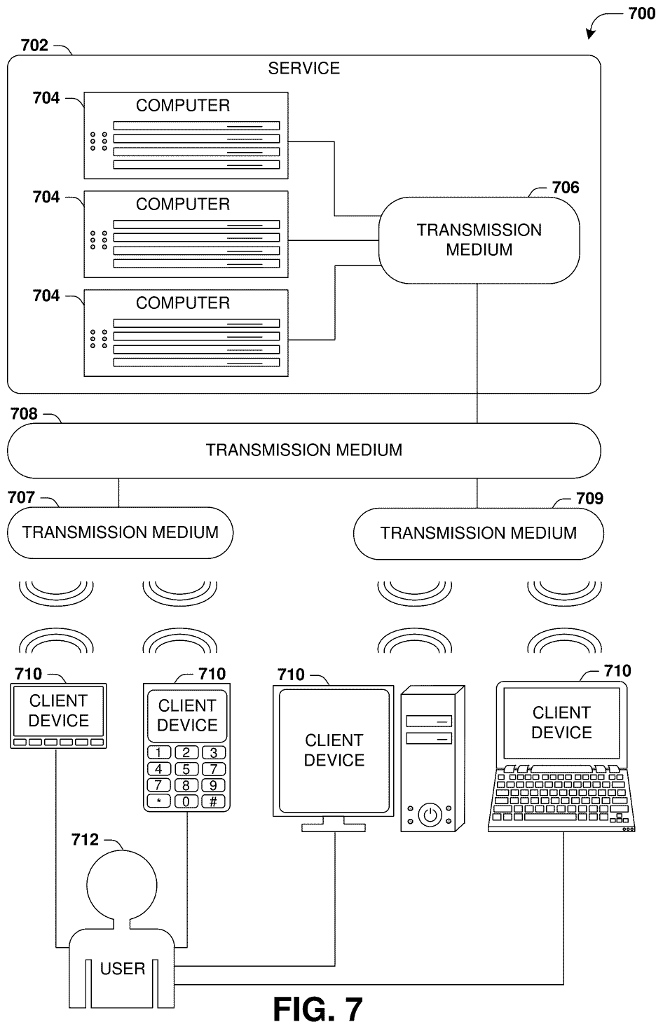

FIG. 8 presents a schematic architecture diagram 800 of a computer 704 that may utilize at least a portion of the techniques provided herein. Such a computer 704 may vary widely in configuration or capabilities, alone or in conjunction with other computers, in order to provide a service such as the service 702.

The computer 704 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 704 may comprise memory 802 storing various forms of applications, such as an operating system 804; one or more computer applications 806; and/or various forms of data, such as a database 808 or a file system. The computer 704 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 704 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 704 with at least one other computer. Other components that may optionally be included with the computer 704 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 704 to a state of readiness.

The computer 704 may operate in various physical enclosures, such as a desktop or tower, and/or may be integrated with a display as an “all-in-one” device. The computer 704 may be mounted horizontally and/or in a cabinet or rack, and/or may simply comprise an interconnected set of components. The computer 704 may comprise a dedicated and/or shared power supply 818 that supplies and/or regulates power for the other components. The computer 704 may provide power to and/or receive power from another computer and/or other devices. The computer 704 may comprise a shared and/or dedicated climate control unit 820 that regulates climate properties, such as temperature, humidity, and/or airflow. Many such computers 704 may be configured and/or adapted to utilize at least a portion of the techniques presented herein.

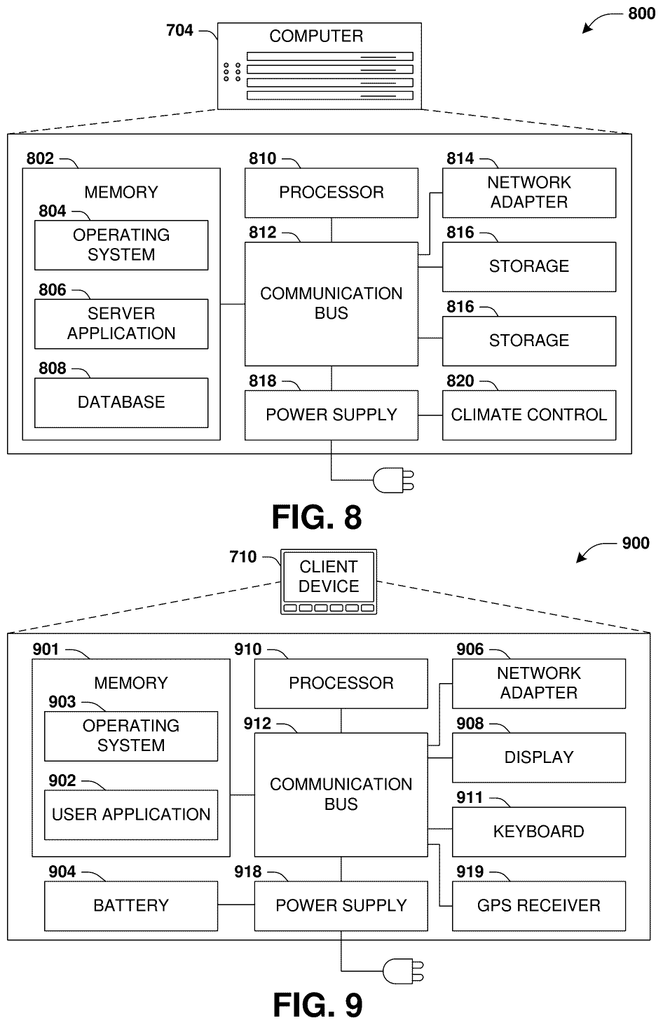

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

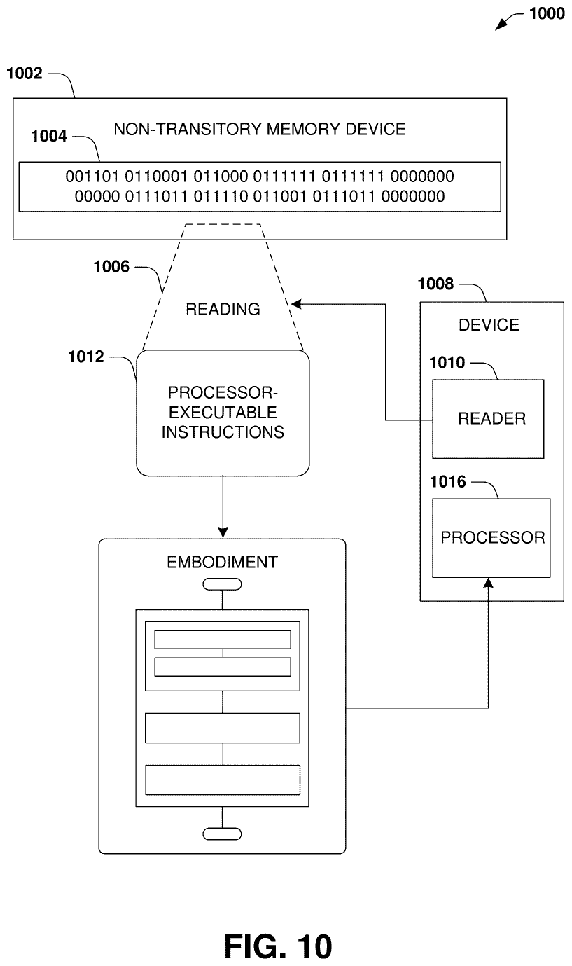

FIG. 10 is an illustration of a scenario 1000 involving an example non-transitory machine readable medium 1002. The non-transitory machine readable medium 1002 may comprise processor-executable instructions 1012 that when executed by a processor 1016 cause performance (e.g., by the processor 1016) of at least some of the provisions herein. The non-transitory machine readable medium 1002 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 1002 stores computer-readable data 1004 that, when subjected to reading 1006 by a reader 1010 of a device 1008 (e.g., a read head of a hard disk drive, or a read operation invoked on a solid-state storage device), express the processor-executable instructions 1012. In some embodiments, the processor-executable instructions 1012, when executed cause performance of operations, such as at least some of the example method 300 of FIG. 3, for example. In some embodiments, the processor-executable instructions 1012 are configured to cause implementation of a system, such as at least some of the example system 100 of FIG. 1, at least some of the example system 401 of FIGS. 4A and 4B, at least some of the example system 500 of FIG. 5, and/or at least some of the example system 600 of FIG. 6.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed:

1. A method, comprising:
constructing a search structure used to partition tasks, wherein the search structure represents time constraints for performing the tasks and distance constraints corresponding to locations of the tasks;
performing a search of the search structure to identify a set of nearest tasks with respect to a target task by:
traversing down the search structure through a path corresponding to the target task until reaching a leaf node;
determining distance metrics for each task corresponding to the leaf node based upon the time constraints and distance constraints, wherein the distance metrics are used to include a select number of the tasks in the set of nearest tasks; and
traversing, from the leaf node, up the search structure to a parent node to determine whether to skip a branch off the parent node or process the branch to determine whether to replace a first task within the set of nearest tasks with a second task within the branch, wherein:
a bound of a distance metric for the parent node is determined; and
in response to the bound being larger than a first distance metric of the first task, skipping, by the search, the branch; and
in response to completing the search, instructing an entity to perform tasks within the set of nearest tasks.

2. The method of claim 1, comprising:
in response to the bound being smaller than the first distance of the first task, replacing the first task within the set of nearest tasks with the second task within the branch.

3. The method of claim 1, comprising:
sorting the tasks corresponding to the leaf node based upon the distance metrics to create a sorted list of tasks; and
selecting the select number of the tasks from the sorted list of tasks to include within the set of nearest tasks.

4. The method of claim 1, comprising:
iteratively performing search operations upon the search structure to assign tasks to entities to perform based upon the time constraints and distance constraints; and
generating a schedule for the entities based upon the tasks assigned to the entities.

5. The method of claim 1, wherein the instructing comprises:
transmitting an instruction over a network to a computing device for display to the entity, wherein the instructions is populated with instructions for performing the set of nearest tasks.

6. The method of claim 1, wherein the entity comprises a robotic device, and wherein the instructing comprises:
transmitting a command over a network to the robotic device to control the robotic device to perform the set of nearest tasks.

7. The method of claim 1, wherein the time constraints comprises a time of day constraint corresponding to a time window during which a task is to be performed.

8. The method of claim 1, wherein the time constraints comprises a date constraint corresponding to date during which a task is to be performed.

9. The method of claim 1, wherein the constructing comprises:
storing ranges of time intervals within branches of the search structure based upon the time constraints corresponding to time of day constraints.

10. The method of claim 1, wherein the constructing comprises:
selecting a dimension to partition the search structure based upon the dimension maximizing a distance between a first branch and a second branch of the search structure.

11. The method of claim 1, wherein the constructing comprises:
selecting spatial dimensions for partitioning the search structure;
partitioning the search structure by a median of the spatial dimensions; and
storing the median as a boundary value.

12. The method of claim 1, wherein the constructing comprises:
selecting temporal dimensions for partitioning the search structure;
partitioning the search structure by a median of a midpoint of time intervals of the temporal dimensions; and
storing a range of the time intervals in each branch of the search structure.

13. The method of claim 1, wherein the constructing comprises:
combining multiple time intervals for a task into a combined time interval for the task.

14. The method of claim 1, wherein the constructing comprises:
inserting a first instance of a task into the search structure for a first time interval for the task; and
inserting a second instance of the task into the search structure for a second time interval for the task.

15. The method of claim 1, wherein the constructing comprises:
determining that a task can be performed during multiple time intervals;
determining whether to combine the multiple time intervals for representing the task within the search structure or insert separate instances of the task into the search structure for each of the multiple time intervals based upon a distance between each time interval.

16. A computing device comprising:
a memory comprising instructions; and
a processor coupled to the memory, the processor configured to execute the instructions to facilitate performance of operations comprising:
performing a search of a search structure, used to partition tasks and represent time constraints for performing the tasks and distance constraints corresponding to locations of the tasks, to identify a set of nearest tasks with respect to a target task by:
traversing down the search structure through a path corresponding to the target task until reaching a leaf node;
determining distance metrics for each task corresponding to the leaf node based upon the time constraints and distance constraints, wherein the distance metrics are used to include a select number of the tasks in the set of nearest tasks; and
traversing, from the leaf node, up the search structure to a parent node to determine whether to skip a branch off the parent node or process the branch to determine whether to replace a first task within the set of nearest tasks with a second task within the branch, wherein:
a bound of a distance metric for the parent node is determined; and
in response to the bound being larger than a first distance metric of the first task, skipping, by the search, the branch; and
in response to completing the search, instructing an entity to perform tasks within the set of nearest tasks.

17. The computing device of claim 16, wherein the operations comprise:
in response to the bound being smaller than the first distance of the first task, replacing the first task within the set of nearest tasks with the second task within the branch.

18. The computing device of claim 16, wherein the operations comprise:
sorting the tasks corresponding to the leaf node based upon the distance metrics to create a sorted list of tasks; and
selecting the select number of the tasks from the sorted list of tasks to include within the set of nearest tasks.

19. A non-transitory computer-readable medium storing instructions that when executed facilitate performance of operations comprising:
performing a search of a search structure, used to partition tasks and represent time constraints for performing the tasks and distance constraints corresponding to locations of the tasks, to identify a set of nearest tasks with respect to a target task by:
traversing down the search structure through a path corresponding to the target task until reaching a leaf node;
determining distance metrics for each task corresponding to the leaf node based upon the time constraints and distance constraints, wherein the distance metrics are used to include a select number of the tasks in the set of nearest tasks; and
traversing, from the leaf node, up the search structure to a parent node to determine whether to skip a branch off the parent node or process the branch to determine whether to replace a first task within the set of nearest tasks with a second task within the branch, wherein:
a bound of a distance metric for the parent node is determined; and
in response to the bound being larger than a first distance metric of the first task, skipping, by the search, the branch; and
in response to completing the search, instructing an entity to perform tasks within the set of nearest tasks.

20. The non-transitory computer-readable medium of claim 19, wherein the operations comprise:
in response to the bound being smaller than the first distance of the first task, replacing the first task within the set of nearest tasks with the second task within the branch.
